(19) United States
(12) Patent Application Publication
(10) Pub. No.: US 2008/0101492 A1
(43) Pub. Date: May 1, 2008

(54) Method for Tracking Phase Noise in an OFDM System

(76) Inventors: Jean-Philippe Gregoire, Jalhay (BE); Eric Backus, Bothell, WA (US); Dennis O'Brien, Marysville, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/554,814

(22) Filed: Oct. 31, 2006

(51) Int. Cl. H04L 1/02

(52) U.S. Cl. 375/267

(57) ABSTRACT

A method for tracking and compensating phase noise in an OFDM communication system, includes:
applying to the OFDM communication system a signal comprising a set of pilot tones, each pilot tone comprising a pilot symbol,
prerotating the signal applied to the OFDM communication system,
constructing for each pilot tone a reference value for the pilot symbol on that pilot tone, said reference value taking into account the distortion the signal has undergone,
correlating for each pilot tone comprised in the prerotated signal the reference value with the pilot symbol, yielding a phase offset value for that pilot tone,
averaging the various phase offset values of the pilot tones to yield an averaged offset value, indicative of the phase noise,
rotating the received symbol according to the averaged offset value, such that the phase noise is compensated for.

The disclosed embodiments relate to a method for tracking and compensating phase noise in an OFDM communication system.

### BACKGROUND

In any wireless device phase tracking is necessary to compensate for the phase noise present in any local oscillator. The local oscillator doesn't have a perfectly constant frequency and any deviation from its nominal frequency induces a frequency offset. In a receiver or in a signal analyzer this results in two distinct effects: a rotation of the received complex symbols (causing a visible rotation on the constellation plot) due to close-to-carrier phase noise and a noise-like additive signal due to far-from-carrier phase noise. Any specification document of a local oscillator contains indications of phase noise values at different offset frequencies. Phase noise can accurately be measured and the resulting deviation from the nominal frequency can be simulated. FIG. 1 illustrates the typical rotational effect of close-to-carrier phase noise on the constellation symbols. The acronym ‘EVM’ in FIG. 1 denotes the Error Vector Magnitude. The simulation was performed with an air interface according to the IEEE802.11n standard, with four independent streams and phase noise added in the receiver only.

In today's OFDM systems tracking and compensating for the close-to-carrier phase noise is made possible by reserving some subcarriers of the subcarrier set for synchronisation purposes. The subcarriers used for synchronisation are called pilot tones. Each pilot tone carries a pilot symbol. Fortunately, the close-to-carrier phase noise present in the received signal affects all subcarriers in the same way. For this reason, the close-to-carrier phase noise component is often called ‘common phase noise’ (CPN). This is of importance, because it means that a value of the CPN obtained for one subcarrier can be applied to the other subcarriers. Note that the part of the phase noise due to far-from-carrier phase noise cannot be compensated for.

In classical Single Input/Single Output (SISO) OFDM systems the CPN is computed and removed after equalization (whereby the channel effect is removed). This is done by first correlating the pilot tones with their known ideal values, which yields an approximation of CPN for each symbol and subsequently applying the inverse rotation.

However, when considering tracking in a Multiple Input/Multiple Output (MIMO) communication, several other factors have to be taken into account:
pilot signals from different streams are rotated,
if at the transmit side spatial streams are mapped onto different transmit chains (spatial mapping—see FIG. 2) (by multiplication of the streams with a mixing matrix), the pilot signals get mixed,
the channel itself mixes pilot signals from the different branches,
one local oscillator (LO) per input/output stream is necessary. They can be either locked, shared or (worst case) not shared nor locked.

Traditional MIMO systems often use at least shared or locked local oscillators. At the receiver side a local oscillator produces a signal that gets mixed with the RF signal to downconvert it from a radio frequency (RF) to baseband or to an intermediate frequency (IF). One downconversion is necessary per RF chain. Hence, if there are N RF chains, N downconversion operations are required. In traditional multichannel systems, the signal used to downconvert the N chains comes from the same local oscillator (LO). So, in this case, the LO is ‘shared’ among the N RF chains. If several LOs are used, another option to make them behave as if they were shared is to ‘lock’ them. In that case, a special mechanism is used to phase align the output signals from the different LOs. Even if they are mixed a same rotation can be observed on each combination of the different streams. This implies that the tracking scheme for a MIMO system is not so different from that of a SISO system: after the MIMO decoding (corresponding to equalization in SISO), and possibly spatial demapping, the tracking is carried out per stream, using the same ideal pilot values as in the transmitter.

However, in the above the hypothesis is assumed that the Local Oscillators are shared or locked, so the CPN components from different streams are obviously correlated. This is not the case anymore when samples are taken at different moments in time: the CPN components then are not ‘correlated’ anymore. Moreover, if in the transmitter the LOs are neither shared, the result is the same: different CPN components get mixed and it becomes impossible to track them. Hence, there is a need to overcome this problem.

### SUMMARY

The presently disclosed embodiments aim to provide a method for tracking and compensating phase noise in an OFDM communication system that is suitable for both SISO and MIMO systems and that overcomes the drawbacks of the prior art solution.

The embodiments presented relate to a method for tracking and compensating phase noise in an OFDM communication system, comprising the steps of:
applying to the OFDM communication system a signal comprising a set of pilot tones, each pilot tone comprising a pilot symbol,
prerotating the signal applied to the OFDM communication system,
constructing for each pilot tone a reference value for the pilot symbol on that pilot tone, said reference value taking into account the distortion the signal has undergone,
correlating for each pilot tone comprised in the prerotated signal the reference value with the pilot symbol, yielding a phase offset value for that pilot tone,
averaging the various phase offset values of the pilot tones to yield an averaged offset value, indicative of the phase noise,
rotating the received symbol according to the averaged offset value, such that the phase noise is compensated for.

In a preferred embodiment the distortion comprises the channel distortion introduced by the channel over which said applied signal is transmitted.

The method is advantageously applied to a multiple input/multiple output (MIMO) OFDM communication system. The distortion then comprises also the effect of a multiplication with a spatial mapping matrix. The spatial mapping can be performed by applying a direct mapping, spatial expansion, beamforming or by cyclic shift diversity.

Preferably the signal is prerotated by a value equal to the averaged offset value determined for a previously applied signal.

In a specific embodiment the OFDM communication system is a signal analyser.

In another aspect the embodiments relate to a method for MIMO communication wherein a downconversion from RF to baseband or IF frequency is applied and wherein a step of tracking and compensating phase noise is performed with the method as previously described, before carrying out a MIMO decoding operation.

### BRIEF DESCRIPTION OF DRAWINGS

FIG. 1 represents symbol constellations impaired by phase noise.

FIG. 2 represents the mapping of spatial streams onto different transmit chains.

FIG. 3 represents a block scheme of a receiver arranged for applying the disclosed method.

FIGS. 4A and 4B represent some constellations with the tracking method disabled (FIG. 4A) and enabled (FIG. 4B).

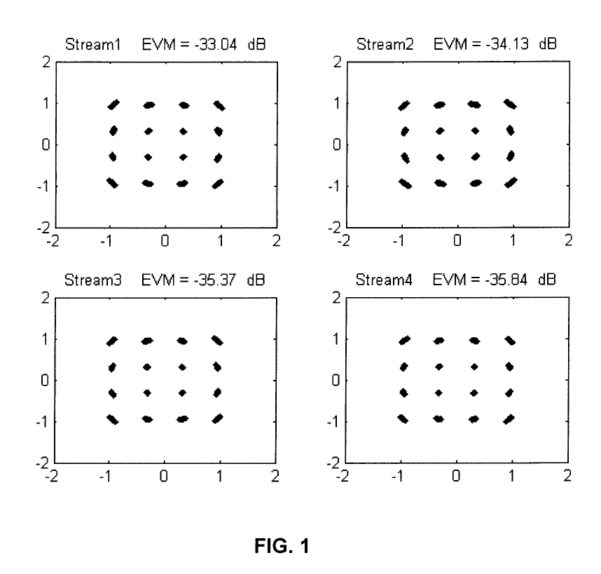

### DETAILED DESCRIPTION

A closer look at the MIMO receiver scheme shows that the signals with different CPNs only get mixed in the MIMO decoding block (if another method is used to decode than a per stream equalization) and in the spatial demapping block.

The solution according to the disclosed embodiments therefore proposes to perform the tracking before the MIMO decoding block. This means there are some important challenges to tackle. Firstly, the channel has to be taken into account as it has not been equalized yet. Further, in case the spatial mapping is performed by spatial expansion (i.e. by spreading the spatial streams to the transmit chain by multiplying them with a Hadamard mixing matrix) or by beam forming (i.e. predistorting the transmitted MIMO signal based on the channel characteristic in such a way that each stream is steered in the spatial domain to its proper destination user) one needs to cope with mixed pilot signals due to the spatial mapping.

Spatial mapping can be illustrated by the following short example. Assuming there are two input streams, denoted by a (complex symbols) vector [St1 St2]. The spatial mapping is a mapping method of the streams St1 and St2 to the transmit chains Tc1 and Tc2. The mapping is made of linear combinations of the inputs. The multiplication of the vector [St1 St2] by a “mixing’ matrix Qₖ can therefore be expressed as:

$$[ \begin{matrix}{Tc}_{1} \\ {Tc}_{2}\end{matrix} ] = [ \begin{matrix}{q}_{11} & {q}_{12} \\ {q}_{21} & {q}_{22}\end{matrix} ] \cdot [ \begin{matrix}{St}_{1} \\ {St}_{2}\end{matrix} ]$$

An important asset of the method disclosed herein is that the tracking is independent from the MIMO decoding algorithm used. For example, if the decoding algorithm is not linear, tracking would become difficult if it is performed after equalization. Moreover, if the local oscillators (LOs) in the transmitter are shared or locked, the tracking can still be carried out even if a real channel is placed in between (emulator or wireless channel) and even if a solution where a receiver would switch in time between the different received channels is used.

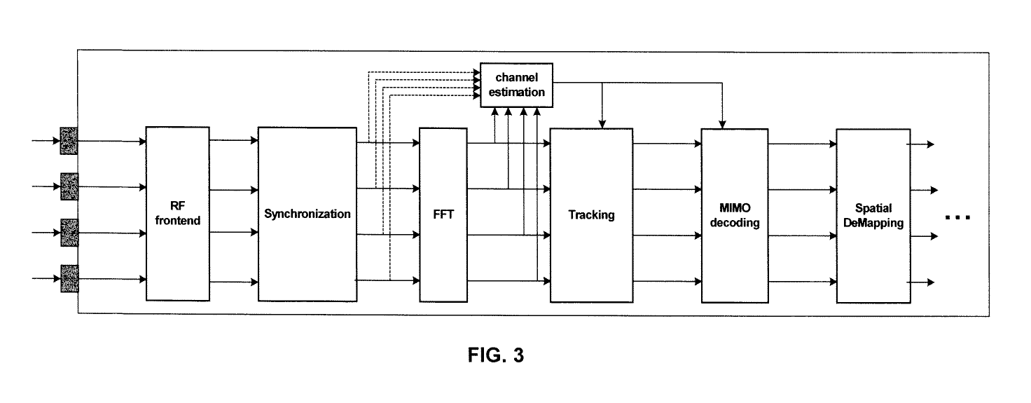

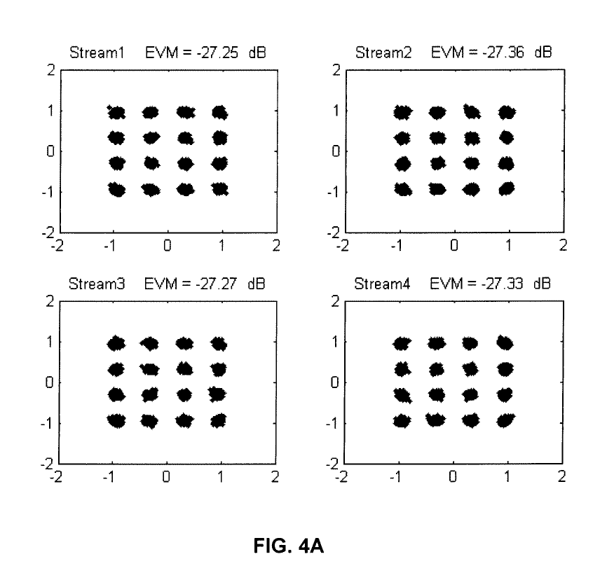

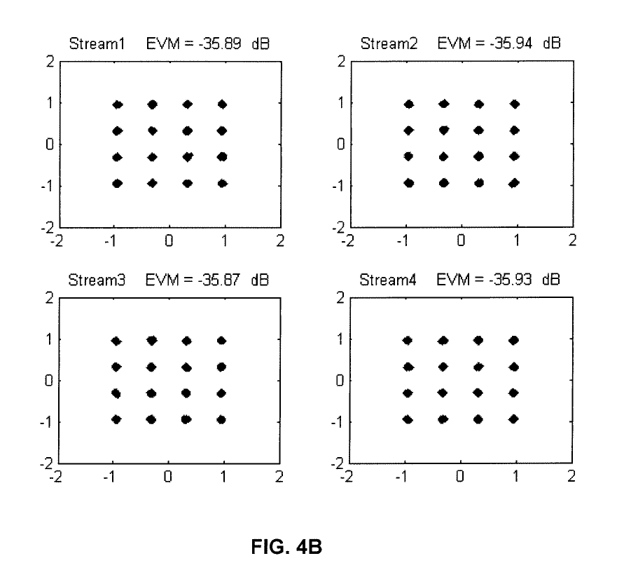

As already mentioned, the tracking is performed before the MIMO decoding, as shown in the block scheme of FIG. 3. As in the state of the art method, the tracking is carried out on pilot tones. The basic idea is to distort, rotate and mix the ideal pilots to match the changes that occurred in the spatial mapping (if spatial expansion or beam forming was used) and in the channel.

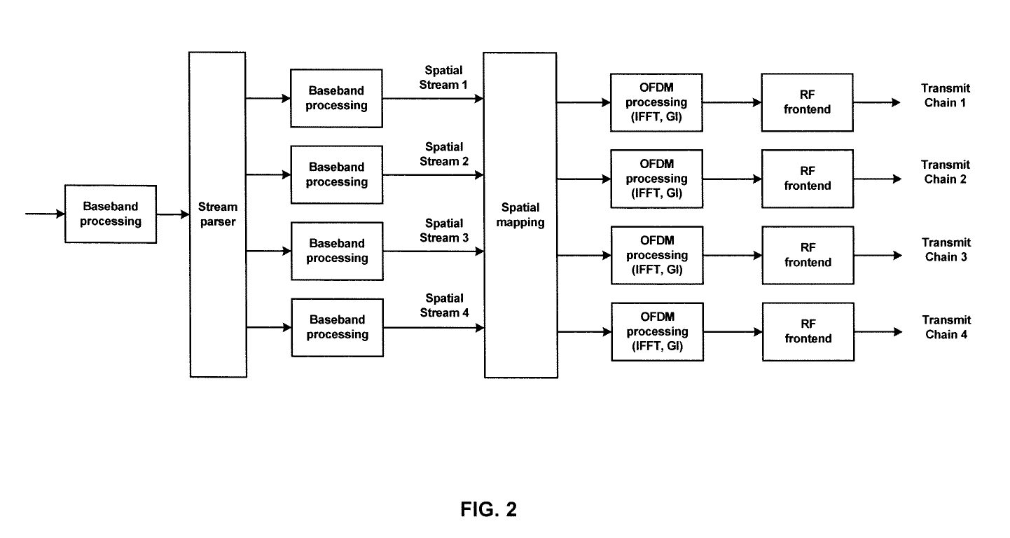

In order to be able to reconstruct the pilot sequence, it is important to have a clear understanding of how the pilot tones are modified at various stages of the transmit/receive process.
1. In the spatial mapping block in the transmitter (FIG. 2), the input signal is multiplied by a matrix. The value of this matrix, denoted Qₖ, depends on the kind of mapping that is applied.
In a ‘direct map’ the input signal is copied to the output and Qₖ simply is the identity matrix. In the case of ‘spatial expansion’ Qₖ is the product of a cyclic shift diversity (CSD) matrix and a Hadamard or Fourier matrix. When beamforming is used, Qₖ can be any matrix. When cyclic shift diversity (CSD) is applied, Qₖ is a diagonal matrix. The cyclic shift diversity mode behaves like the direct map mode except that it introduces an extra variable cyclic shift (i.e. it cyclically rotates the subcarriers) on each spatial stream. Assuming that the spatial mapping operation is seen as the multiplication of the vector of symbols of all spatial streams at time T by a matrix Qₖ, Qₖ will be a diagonal matrix. So each transmit chain input symbol will be composed of a shifted version of the symbol of the corresponding spatial stream.
2. In the RF front-end in the transmitter local oscillator (LO), the different streams suffer from phase noise. The phase noise components are either correlated or not (depending on whether the LOs are shared/locked or not).
3. In the channel the output signal from the transmitter is multiplied by the channel matrix H.
4. In the RF front-end of the receiver (or of a test equipment), the different streams suffer from phase noise. Each phase noise component is either correlated or not (if a multichannel or a switched single channel solution is chosen).

The method assumes knowledge of the spatial mapping matrix Qₖ and of an estimate of the channel matrix. In practice both are available. Note that the matrix Qₖ simply becomes a scalar 1 when the OFDM system is a Single Input/Single Output (SISO) system. Further, as already mentioned, if a direct mapping is used, the matrix Qₖ is an identity matrix. A channel matrix estimate can be derived either blindly or by means of a known preamble field (if present), as is well known in OFDM communication systems.

The tracking algorithm itself can be described by the following steps:
prerotating the signal by the compensation value from the previous symbol (by 0 if it is the first symbol),
constructing for each pilot tone a reference value for the pilot symbol on that pilot tone, this reference value being computed by applying a distortion on the pilot symbol based on the knowledge of the matrix Qₖ and the estimate of the channel,
computing a phase offset value per pilot tone on this prerotated signal by correlating the composite pilot value with the received pilot value,
averaging the values for all pilot tones in one OFDM symbol in order to obtain the final offset,
rotating the entire symbol according to that averaged value,
updating the value for prerotating the next symbol.

In a specific embodiment the MIMO receiver system can be a signal analyser. This may occur when the method is applied on a test set-up wherein test equipment is used. This implies that the connections consist of wires. The channel matrix can then be considered diagonal. In this case the CPNs from the transmitter local oscillators (LOs) don't get mixed in the channel. At the receiver side one disposes of knowledge about the Qₖ matrix and the channel matrix H. So if the pilot ideal values are taken for each transmitter stream, one can construct ‘composite’ pilot values for each receiver stream by multiplying the pilot vector (vector corresponding to one subcarrier and containing Nₛₜᵣₑₐₘₛ values, whereby Nₛₜᵣₑₐₘₛ denotes the number of spatial streams at the input of the spatial mapping block) by the matrix Qₖ and subsequently multiplying the resulting vector by the channel matrix H.

The application field of the disclosed embodiments is not restricted to receivers only. It fits any application that needs the downconversion of an OFDM signal from RF to baseband or IF (intermediate frequency), as this downconversion implies the mixing of the RF signal with a carrier coming from one or several local oscillators.

### Besides signal analyzers or pure receivers, a MIMO (or SISO) channel emulator can be cited as an example.

In such equipment, the signal is being distorted to mimic a certain channel profile. Typically, OFDM signals are distorted in the frequency domain and at baseband. If such equipment has RF inputs, phase noise appears as a downconversion is required. Consequently, it is necessary to track the phase noise. The present method can be therefore applied.

What is claimed is:

1. A method for tracking and compensating phase noise in an OFDM communication system, comprising:
applying to said OFDM communication system a signal comprising a set of pilot tones, each pilot tone comprising a pilot symbol,
prerotating said signal applied to said OFDM communication system,
constructing for each pilot tone a reference value for said pilot symbol on said pilot tone, said reference value taking into account the distortion said signal has undergone,
correlating for each pilot tone comprised in said prerotated signal said reference value with said pilot symbol, yielding a phase offset value for said pilot tone,
averaging said various phase offset values of said pilot tones to yield an averaged offset value, indicative of said phase noise, and
rotating said received symbol according to said averaged offset value, such that said phase noise is compensated for.

2. in the method of claim 1, wherein said distortion comprises the channel distortion introduced by the channel over which said applied signal is transmitted.

3. The method of claim 1, wherein said OFDM communication system is a multiple input/multiple output (MIMO) OFDM communication system.

4. The method of claim 3, wherein said distortion comprises the effect of a multiplication with a spatial mapping matrix.

5. The method of claim 3, wherein the spatial mapping is performed by direct mapping, spatial expansion, beamforming or by exploiting cyclic shift diversity.

6. The method of claim 1, whereby said signal is prerotated by a value equal to the averaged offset value determined for a previously applied signal.

7. The method of claim 1, whereby said OFDM communication system is signal analyzer.

8. A method of MIMO communication comprising: downconverting from RF to baseband or IF frequency, and tracking and compensating phase noise as in claim 3 before carrying out a MIMO decoding operation.
